(19) United States
(12) Patent Application Publication
(10) Pub. No.: US 2007/0074079 A1
(43) Pub. Date: Mar. 29, 2007

(54) System and method for providing trigger information in a video signal and playing out a triggered event

(76) Inventors: Darren P. Forster, Stamford, CT (US); Samuel W. D. Pemberton, Darien, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/526,986

(22) Filed: Sep. 26, 2006

Related U.S. Application Data
(60) Provisional application No. 60/721,336, filed on Sep. 27, 2005.

(51) Int. Cl. G06F 11/00

(52) U.S. Cl. 714/38

(57) ABSTRACT

A system for providing trigger information in a video signal and outputting a triggered event comprises a distribution facility and at least one head-end facility. The distribution facility includes an automation system, a trigger unit, and a data inserter. The automation system controls video and audio sources to play out the program events to provide a video signal, and outputs the event identifier when the associated program event is played out. The trigger unit outputs a trigger identifier associated with the event identifier. The data inserter inserts the trigger identifier in a portion of a vertical blanking interval of the video signal. The head-end facility includes a decoder and a content server. The decoder detects the trigger identifier in the portion of the vertical blanking interval of the video signal. The content server plays out the triggered event.

### CROSS REFERENCE TO RELATED APPLICATION(S)

This application claims the benefit of U.S. Provisional Application No. 60/721,336, filed Sep. 27, 2005, which is incorporated by reference as if disclosed herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright whatsoever.

### BACKGROUND

Over the course of half a century, the television industry has seen many startling advances. One such recent advance is the advent of interactive television (iTV). From video on demand and on-screen program guides (EPGs) to the ability to book your next holiday right from your remote control, iTV promises a more encompassing and streamlined television experience.

The ability of television to capture an audience is key, and broadcasters, well aware of the increase in “noise” from other media, are keener than ever to hook audiences to their shows. However, a “two screen” approach to interactivity (i.e., employing both a television screen and a separate personal computer screen) can push viewers away from the program and toward the computer. Far better, for both the viewer and the broadcaster, is an interactive experience that allows the viewer to interact through the TV.

However, because of the distribution mechanism employed by networks and cable operators, some issues arise. For example, the distribution of network content is generally achieved over satellite. Because of the cost of transponder bandwidth, very little beyond what is absolutely needed is contracted for (e.g., video and audio). For this reason it is likely that non-real-time content will have the interactive portion of the content delivered to a final head-end distribution facility (such as a cable head-end or a satellite uplink facility) prior to the airing time. This situation creates the need for a trigger system to be developed that will allow the video/audio content to cue, initiate, or otherwise trigger the play out of pre-timed interactive content. While a number of mechanisms can be employed to solve this problem, most would require extensive modification or rewiring of existing equipment, which can be an extremely expensive and time consuming ordeal.

### BRIEF SUMMARY

In one aspect, there is provided a system for providing trigger information in a video signal. The system comprises an automation system, a trigger unit, and a data inserter. The automation system includes an automation system schedule, which includes an event identifier and a start time for each program event in a plurality of program events. The automation system outputs the event identifier at the start time of each event to control video and audio sources in the creation of a video signal. The trigger unit receives the event identifier from the automation system and compares the event identifier from the automation system with at least one event identifier in a trigger schedule to determine if the event identifier from the automation system is included in the trigger schedule. In response to determining the event identifier from the automation system is included in the trigger schedule, the trigger unit outputs trigger information associated with the event identifier. The data inserter inserts the trigger information from the trigger unit into a portion of a vertical blanking interval of the video signal. The portion of the vertical blanking interval may include an extended data service auxiliary channel. Also, the trigger information may identify an interactive television application.

In another aspect, there is provided a system for outputting a triggered event. The system comprises a decoder and a content server. The decoder detects a unique identifier in a portion of a vertical blanking interval of a video signal. The content server compares the detected unique identifier with at least one unique identifier in a content server schedule to determine if the detected unique identifier is included in the content server schedule. In response to determining the detected unique identifier is included in the content server schedule, the content server plays out a triggered event associated with the unique identifier.

In yet another aspect, there is provided a system for providing trigger information in a video signal and outputting a triggered event. The system comprises a distribution facility and at least one head-end facility. The distribution facility includes an automation system, a trigger unit, and a data inserter. The automation system includes an automation system schedule, which includes an event identifier and a start time for each program event in a plurality of program events. The automation system outputs the event identifier at the start time of each event to control video and audio sources in the creation of a video signal. The trigger unit receives the event identifier from the automation system and compares the event identifier from the automation system with at least one event identifier in a trigger schedule to determine if the event identifier from the automation system is included in the trigger schedule. In response to determining the event identifier from the automation system is included in the trigger schedule, the trigger unit outputs trigger information associated with the event identifier. The trigger information includes a unique identifier. The data inserter inserts the trigger information from the trigger unit into a portion of a vertical blanking interval of the video signal. The head-end facility includes a decoder and a content server. The decoder detects the unique identifier in the portion of the vertical blanking interval of the video signal. The content server compares the detected unique identifier with at least one unique identifier in a content server schedule to determine if the detected unique identifier is included in the content server schedule. In response to determining the detected unique identifier is included in the content server schedule, the content server plays out a triggered event associated with the unique identifier.

In yet another aspect, there is provided a method for providing trigger information in a video signal and outputting a triggered event, the method comprises: comparing an event identifier received from an automation system with at least one event identifier in a trigger schedule to determine if the event identifier is included in the trigger schedule; in response to determining the event identifier is included in the trigger schedule, outputting trigger information associated with the event identifier; inserting the trigger information into a portion of a vertical blanking interval of the video signal; detecting the trigger information in the portion of the vertical blanking interval of the video signal; comparing the detected trigger information with trigger information in a content server schedule to determine if the detected trigger information is included in the content server schedule; and in response to determining the trigger information is included in the content server schedule, playing out a triggered event associated with the trigger information.

In any of the above aspects, the portion of the vertical blanking interval may include an extended data service auxiliary channel, and the triggered event may include an interactive television application.

### BRIEF DESCRIPTION OF THE DRAWING

Referring now to the drawing wherein like items are numbered alike in the various Figures:

FIG. 1 is a schematic depiction of a system for providing trigger information in a video signal and outputting a triggered event in response to the trigger information according to one embodiment of the present invention;

FIG. 2 is an example of an automation system schedule according to one embodiment of the present invention;

FIG. 3 is an example of a trigger schedule according to one embodiment of the present invention;

FIG. 4 is an example of a content server schedule according to one embodiment of the present invention; and

FIG. 5 is a flowchart of a method of providing trigger information in a video signal and outputting a triggered event according to one embodiment of the present invention.

### DETAILED DESCRIPTION

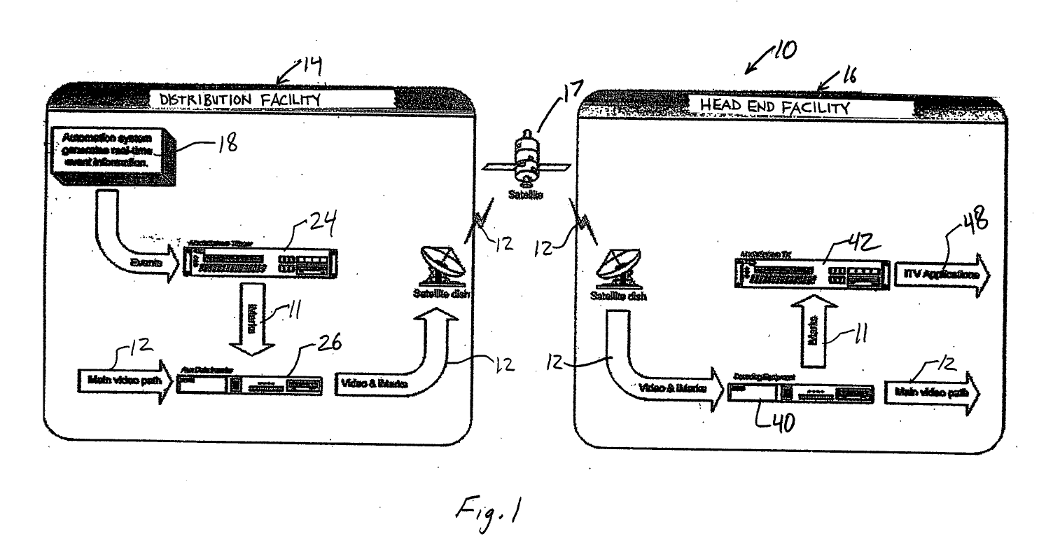

FIG. 1 depicts an example of a system 10 for providing trigger information 11 in a video signal 12 and playing out a triggered event in response to the trigger information 11. The system 10 includes a distribution facility 14, which may be operated by a television (TV) network, and one or more head-end facilities 16, which may be operated by TV stations, cable TV service providers, satellite TV service providers, or the like. The distribution facility 14 and head-end facility 16 send and receive the video signal 12 by a satellite communications link or other suitable communications link 17. As will be described in further detail hereinafter, the system 10 uses a portion of the Vertical Blanking Interval (VBI) of the video signal 12 (e.g., the Extended Data Services (XDS) auxiliary data channels) to transmit trigger information (iMarks) 11 from the distribution facility 14 to each head-end facility 16. XDS is an American standard classified under Electronic Industries Alliance standard EIA-766, which is incorporated herein by reference in its entirety, for the delivery of any ancillary data (metadata) to be sent with an analog television program or any other NTSC video signal. XDS uses the same line in the VBI as closed captioning (NTSC line 21), but it utilizes the second video field (as opposed to closed captioning line 21, field 1). Since the XDS data is already used in most studios, the vast majority of operations are already equipped with the necessary decoding equipment. As a result, the use of XDS as an iTV event triggering system will eliminate the need for expensive modifications to existing equipment. The trigger information 11 is used to trigger the play out of triggered events (e.g., interactive TV (iTV) applications) at the head-end facilities 16 to the TV audience.

The distribution facility 14 includes an automation system 18, which is typically used to control TV services. A modem TV service is created using many playout devices (not shown) to generate the video, audio, and captioning components of the video signal 12, and it is the responsibility of the automation system 18 to ensure that the correct content is delivered at the correct time.

Stored within the automation system 18 is a schedule showing each event in the service and a time at which time that event is required. An event may include, for example, a single advertisement or program segment. As time passes, it is the responsibility of the automation system 18 to ensure that each item of playout equipment knows what event of the service is required.

FIG. 2 depicts an example of an automation system schedule 20. In the schedule 20, program event is identified by a program event identifier 22 (Material ID). The schedule 20 also includes a description of each program event (Description), and indicates when each program event should occur (Start Time). For example, the fifth event in the schedule has a program event identifier “CAR-AD1,” and is described as a “CAR ADVERT”, with a start time of 10:05:02:00. If this event is an iTV item, for example, the automation system schedule 20 does not treat this event any differently than the other events in the schedule 20.

Referring again to FIG. 1, the distribution facility 14 also includes a trigger unit 24, which is responsible for outputting the correct trigger information 11 in response to instructions from the automation system 18 as to which program event is currently being played. The distribution facility 14 further includes an auxiliary data inserter 26, which inserts the trigger information 11 into the VBI (e.g., the XDS auxiliary data channels) of the video signal 12. For example, trigger unit 24 may be a MediaSphere Trigger unit commercially available from Softel-USA of Stamford, Conn. The specific data inserter 26 used will be dependent on the distribution method used by the system 10.

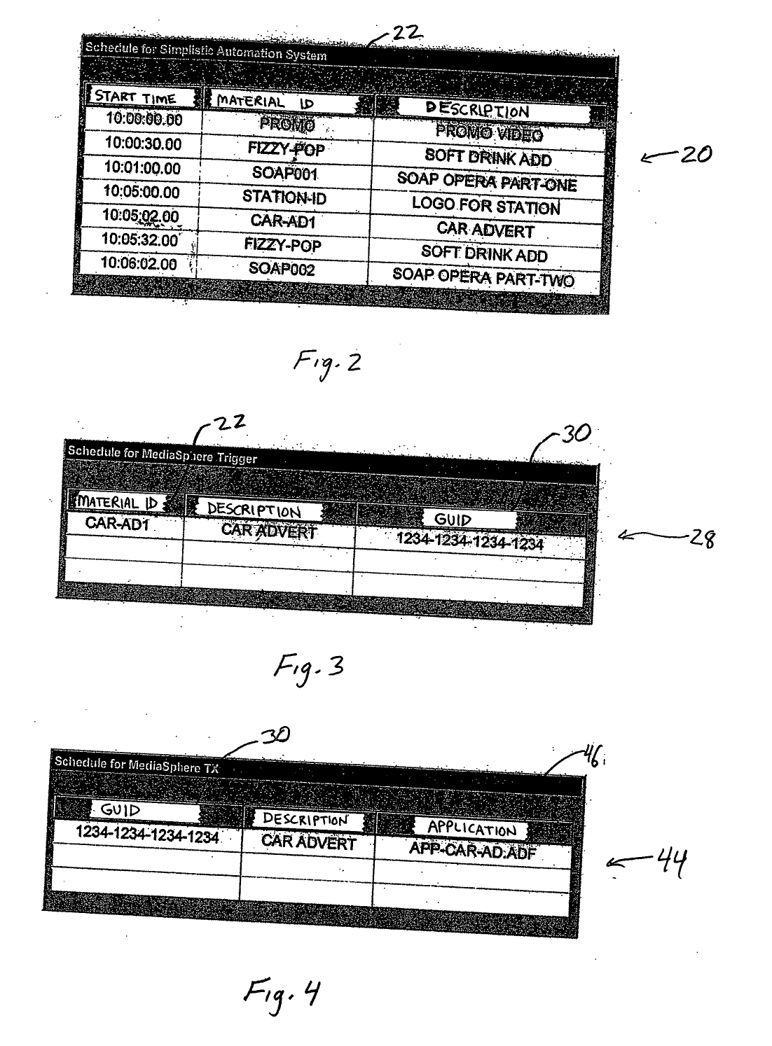

FIG. 3 depicts an example of a trigger schedule 28 that may be stored within the trigger unit 24 (FIG. 1). The trigger schedule 28 contains event identifiers 22 for those events that require a trigger (e.g., an iTV event), and a globally unique identifier (GUID) 30 uniquely identifying the instance of the triggered event. For example, the event having the event identifier “CAR-AD-1” has a unique identifier of “1234-1234-1234-1234”.

In operation, the automation system 18 controls video and audio sources to create a program event in accordance with the automation system schedule 20 (FIG. 2). The automation system 18 instructs the trigger unit 24 as to which program event is currently playing on-air by feeding the associated event identifier 22 to the trigger unit 24. This real-time event information is decoded by the trigger unit 24, which ignores any events that do not match the event identifiers 22 in its trigger schedule 28 (FIG. 3). When the trigger unit 24 detects a match between the received event identifier 22 and an event identifier 22 in the trigger schedule 28, the trigger unit 24 outputs the appropriate trigger information 11 into the video path 12 using the auxiliary data inserter 26. For example, when the trigger unit 24 receives the event identifier “CAR-AD1” it inserts trigger information 11 including the unique identifier “1234-1234-1234-1234” into the broadcast video signal 12. Once embedded, the video signal 12 can be freely distributed to each head-end facility 16, in this example via satellite. The video portion of the signal 12 is completely unaffected by this process.

The trigger information 11 requires very little bandwidth and may be sent infrequently; therefore, it may fit easily into the bandwidth allocated for XDS information in the video signal 12. While the system 10 of FIG. 1 may use XDS auxiliary data channels to transmit the trigger information 11, it is contemplated that other portions of the video signal's VBI may be used.

At the head-end facility 16, a video decoder 40 receives the video signal 12 and decodes the signal 12 to detect the trigger information 11 in the video signal 12. The trigger information 11 is provided from the decoder 40 to a content server 42, which triggers the output of an event (e.g., an iTV application). For example, the content server 42 may include a MediaSphere TX unit commercially available from Softel-USA of Stamford, Conn. MediaSphere TX is a powerful iTV content server, which can broadcast MHP, OCAP, ACAP, MHEG and Open TV applications as part of a digital TV service.

Referring to FIG. 4, an example of a schedule 44 that may be stored within the content server 42 is shown. The content server schedule 44 identifies at least one triggered event 46 to be output by the content server 42. Each triggered event 46 is associated with a unique identifier 30 and a description of the event. In the example shown, the content server 42 will output the triggered event “APP-CAR-AD.ADF” (an iTV application having the description “CAR ADVERT”) upon receipt of trigger information 11 having the event identifier “1234-1234-1234-1234”.

In operation, the content server 42 reads trigger information 11 from the broadcast video signal 12 via the decoder 40. The content server 42 ignores all items of trigger information 11 until one is found which has a unique identifier 30 matching that within the content server schedule 44. When a matching unique identifier 30 is found, the triggered event 46 associated with that unique identifier 30 in the schedule 44 is output by the content server 42 into a digital transport stream 48 so that it can be received by the viewers at home. In this manner, the content server 42 triggers the generation of the correct triggered event 46 at the correct time.

In the example described herein, the trigger information 11 is used to trigger interactive television (iTV) applications, which are played out by the content server 42 and received by the TV audience. It is contemplated, however, that the system 10 has many uses beyond triggering iTV applications. The trigger information 11 could equally be used for control of any downstream remote device, which needs to resolve cues or other triggers from the automation system 18.

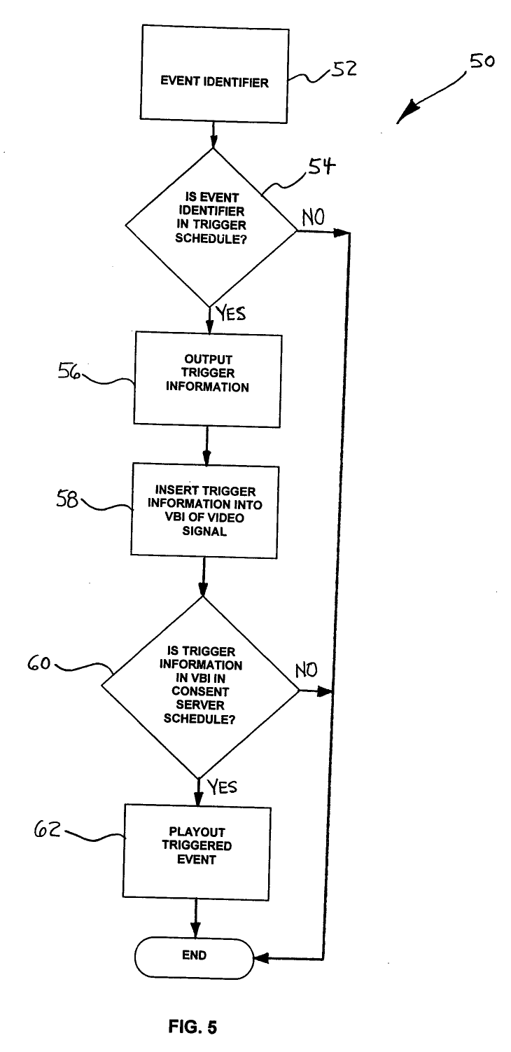

Referring now to FIG. 5, another aspect of the invention is a method 50 for providing trigger information in a video signal and outputting a triggered event. In step 52 of method 50, event identifier 22 is received from automation system 18. Next, at step 54, event identifier 22 is compared with trigger schedule 28 to determine if the event identifier is included in the trigger schedule. If it is determined that event identifier 22 is included in trigger schedule 28, method 50 continues at step 56. At step 56, trigger information 11, which is associated with the event identifier, is output. If it is determined that event identifier 22 is not included in trigger schedule 28, method 50 ends. After completion of step 56, method 50 continues at step 58. At step 58, trigger information 11 is inserted into a portion of a vertical blanking interval of video signal 12. To facilitate understanding of method 50, steps 56 and 58 are illustrated as separate steps. However, in practice, steps 56 and 58 typically occur substantially simultaneously. Then, at step 60, trigger information 11 is compared with any trigger information contained in content server schedule 44 to determine if the trigger information is included in the content server schedule. If it is determined that trigger information 11 is included in content server schedule 44, method 50 continues at step 62. At step 62, triggered event 46, which is associated with trigger information 11, is output into a digital transport stream 48 so that it can be received by viewers. After completion of step 62, method 50 ends. If it is determined that trigger information 11 is not included in content server schedule 44, method 50 ends.

Although described in the context of preferred embodiments, it should be realized that a number of modifications to these teachings may occur to one skilled in the art. While the invention has been particularly shown and described with respect to preferred embodiments thereof, it will be understood by those skilled in the art that changes in form and details may be made therein without departing from the scope and spirit of the invention.

What is claimed is:

1. A system for providing trigger information in a video signal, said system comprising:
an automation system including an automation system schedule, said automation system schedule including an event identifier and a start time for each program event in a plurality of program events, said automation system being configured to output said event identifier at said start time of each event to control video and audio sources in the creation of a video signal;
a trigger unit including a trigger schedule, said trigger unit being configured to receive said event identifier from said automation system, compare said event identifier from said automation system with at least one event identifier in said trigger schedule to determine if said event identifier from said automation system is included in said trigger schedule, and in response to determining said event identifier from said automation system is included in said trigger schedule, said trigger unit being configured to output trigger information associated with said event identifier; and
a data inserter configured to insert said trigger information from said trigger unit into a portion of a vertical blanking interval of said video signal.

2. A system according to claim 1, wherein said portion of said vertical blanking interval includes an extended data service auxiliary channel.

3. A system according to claim 1, wherein said trigger information identifies an interactive television application.

4. A system for outputting a triggered event, said system comprising:
a decoder configured to detect a unique identifier in a portion of a vertical blanking interval of a video signal; and
a content server including a content server schedule, wherein said content server is configured to compare said detected unique identifier with at least one unique identifier in said content server schedule to determine if said detected unique identifier is included in said content server schedule and in response to determining said detected unique identifier is included in said content server schedule, said content server is configured to play out a triggered event associated with said unique identifier.

5. A system according to claim 4, wherein said portion of said vertical blanking interval includes an extended data service auxiliary channel.

6. A system according to claim 4, wherein said triggered event is an interactive television application.

7. A system for providing trigger information in a video signal and outputting a triggered event, said system comprising:
a distribution facility including an automation system, a trigger unit, and a data inserter, said automation system having an automation system schedule, said automation system schedule including an event identifier and a start time for each program event in a plurality of program events, said automation system being configured to output said event identifier at said start time of each event to control video and audio sources in the creation of a video signal, said trigger unit including a trigger schedule, said trigger unit being configured to receive said event identifier from said automation system, said trigger unit being configured to compare said event identifier from said automation system with at least one event identifier in said trigger schedule to determine if said event identifier from said automation system is included in said trigger schedule, and in response to determining said event identifier from said automation system is included in said trigger schedule, said trigger unit being configured to output trigger information associated with said event identifier, said trigger information including a unique identifier, and said data inserter configured to insert said trigger identifier in a portion of a vertical blanking interval of said video signal; and
at least one head-end facility including a decoder and a content server, said decoder configured to detect said unique identifier in said portion of said vertical blanking interval of said video signal, said content server including a content server schedule, wherein said content server is configured to compare said detected unique identifier with at least one unique identifier in said content server schedule to determine if said detected unique identifier is included in said content server schedule and in response to determining said detected unique identifier is included in said content server schedule, play out a triggered event associated with said unique identifier.

8. A system according to claim 7, wherein said portion of said vertical blanking interval includes an extended data service auxiliary channel.

9. A system according to claim 7, wherein said triggered event is an interactive television application.

10. A method for providing trigger information in a video signal and outputting a triggered event, said method comprising:
comparing an event identifier received from an automation system with at least one event identifier in a trigger schedule to determine if said event identifier is included in said trigger schedule;
in response to determining said event identifier is included in said trigger schedule, outputting trigger information associated with said event identifier;
inserting said trigger information into a portion of a vertical blanking interval of said video signal;
detecting said trigger information in said portion of said vertical blanking interval of said video signal;
comparing said detected trigger information with trigger information in a content server schedule to determine if said detected trigger information is included in said content server schedule; and
in response to determining said trigger information is included in said content server schedule, playing out a triggered event associated with said trigger information.

11. A system according to claim 10, wherein said portion of said vertical blanking interval includes an extended data service auxiliary channel.

12. A system according to claim 10, wherein said triggered event is an interactive television application.
